(19) United States
(12) Patent Application Publication
(10) Pub. No.: US 2015/0011290 A1
(43) Pub. Date: Jan. 8, 2015

(54) Secondary Game to Symbol-Matrix Base Game

(71) Applicant: Larry Galansky, London (GB)

(72) Inventor: Larry Galansky, London (GB)

(73) Assignee: LEAPFROG SOFTWARE SYSTEMS LTD, St. Martins (GG)

(21) Appl. No.: 13/934,227

(22) Filed: Jul. 3, 2013

(51) Int. Cl. G07F 17/34

(52) U.S. Cl. CPC G07F 17/34
USPC 463/20

(57) ABSTRACT

The present invention is a gaming device having a secondary game played in conjunction with a symbol-matrix base game. The symbol-matrix game includes a special designation symbol within the symbol set associated with the base game. Occurrences of the special designation symbol in the symbol-matrix base game are spatially re-represented in a secondary matrix that is a mirrored representation of the symbol-matrix from the base game. Through a series of plays of the base game, the occurrences of the special designation symbol accumulate until a pre-determined pattern is established in the secondary matrix indicating a winning outcome of the secondary game.

### BACKGROUND

Slot machines have been a form of entertainment to the public for many decades. They began as mechanical, three-reel devices that, through mechanical means, were made to rotate and then to separately come to a stop; each at a distinct location along the reel. The result would be a series of symbols or blanks—one per reel—that would be displayed horizontally along a payline, each symbol or blank being one in a set of symbols or blanks included on the reel strip. Each displayed symbol or blank corresponded with a distinct stopping point associated with the respective reel. The given combination of displayed symbols or blanks along the payline, which corresponded to the given sequence of stopping points, provided a specific, pre-determined result. When a wager was made to initiate this mechanical action, the pre-determined result would be a winning, losing or draw situation where the player would either be compensated over and above the value of the wager made, lose his wager or receive back his wager.

While this simple form slot machine provided entertainment, it has been the continuous goal of slot machine developers to develop slot machines, including the games that reside therein, with ever-increasing entertainment value. The greater the entertainment value, the greater the machine's use and, generally, the greater revenue received by the slot machine provider.

Over the years, slot machines have been introduced to a number of technological advancements and innovations. Now, a typical slot machine is a video device having video reel representations, colorful graphic displays and animations. The reels have virtual stops greatly outnumbering the number of symbols. This allows the game designer to design the odds of winning certain symbol combination much higher, enabling winning combinations reach large amounts, thus generating even greater excitement and a desire to play.

A player may now select the denomination he or she wishes to play; be it penny, nickel, quarter or higher, the number of paylines to make wager on from a give set of selectable paylines, and a credit wager amount per payline. Thus, if the player selects a denomination of a nickel, five paylines and 10 credits per payline, the player would be making a total wager of $2.50 to play the game. The player would win some pre-determined amount for each pre-determined symbol combination randomly generated along any of the 10 selected paylines. Each winning combination would be paid in credits with each credit equaling one nickel.

To further enhance play, a variety of different bonus games are now included to complement the base game. They can be triggered either randomly or through a specific triggering event from the initial or base game. Some bonus games are simply additional, free plays of the base game. Sometimes the base game may be modified in some fashion to create more interest. Other times the bonus game is entirely separate from the base game though it may be displayed either in the same monitor as the base game, a secondary monitor, or it may be a separate device associated with the gaming machine (a well know example of this would be the physical, spinning wheel used with the WHEEL OF FORTUNE® casino game developed by IGT). Sometimes the bonus game will require player interaction and sometimes it will not. For instance, the Wheel of Fortune game, whether through a physical spinning reel or a simulated reel displayed in a computer monitor, only requires that the player initiate a spin. The wheel then spins. When it stops, the award provided to the player is displayed at a given marker. Player interaction may be required in bonus games where the player selects one of a number of options and is given an award or some other result based on the selection. There are a multitude of different bonus-type games and methods. Much of today's game design is geared towards coming up with new and innovative type bonus events to further amuse and entertain the player.

Progressive jackpots are variable jackpot amounts that grow over time and are funded through contributions made by each player that is given a chance at winning the jackpot. The contributions are made from a portion of the wager made for play of the base game. Therefore, the jackpot continuously grows until it is won and then reset to some pre-determined lower value. These jackpots can be dedicated to a singular gaming machine but are more often associated with a bank of gaming machines that link to a computer server that controls all aspects of the jackpot through a network. These jackpots can be associated with a particular win on the base game, randomly awarded, or associated with a particular win in a bonus game. They are very attractive to players due to the fact that they can grow very large over time and because, when associated with a bank of machines, they provide a sense of enjoyed community among the players. Sometimes there games include progressive jackpot levels. These games split up the progressive jackpot awards contributing a portion of the wager to one distinct jackpot, and one or more differing portions to one or more other distinct jackpots. The jackpot awarded would vary depending on the outcome of the game, with the largest jackpot being awarded for the outcome having the least probability of occurrence.

The creation of networks is now standard practice in most casinos and other gaming locations. The prime reasons for networking is to automate and centralize accounting for all machines on the gaming floor, to track individual players' gaming results and activities, to gain knowledge of game productivity, and to deliver games and other media from a central server to the individual gaming machines. But networks are also established among a bank of gaming machines in order to create shared bonus games and awards or for players to compete for the award.

No game is known that provides a secondary game played over a series of base game plays that associates the base game with the secondary game in the manner of the present invention and that incentivizes the player to continue playing the base game in order to have an opportunity to achieve the desired winning outcome of the secondary game.

### SUMMARY

The present invention is directed to a gaming device and method that provides a secondary or complementary game to a base game. The particular secondary game is associated with the base game, which is a symbol-matrix type game. The secondary game is played during a consecutive series of base game plays and it takes a series of base game plays to enable a winning outcome. This provides incentive to the player to play the base game. Statistically, the more a player plays the base game, the closer player will come to achieving a winning outcome thus further incentivizing play. In this sense, it is similar to the game of Bingo whereby the more number that are called, statistically the more the player's card will be filled and generally the closer the player gets to achieving a Bingo win.

The secondary game begins with a play of the base game. The base game is a symbol-matrix game typical of slot machine games. Each field of the symbol matrix from the symbol-matrix game is populated with symbol from a set of symbols. At least one symbol within the symbol set is specially designated to contain a certain attribute. The base game is evaluated for winning outcomes and the player is paid in accordance with the rules of the particular game. In addition, the symbols randomly generated within the symbol matrix are evaluated to determine if any include the attributes of a special designation symbol. If one or more is discovered, a mark or daub is made in a second matrix that is representative of the symbol-matrix of the base game. Therefore, it includes the same general attributes of the matrix; i.e. the same number of rows and columns as those in the symbol-matrix of the base game, and the same relative positions of the rows and columns to one another as the positions of such in the symbol-matrix of the base game. The location of the mark or daub in the second matrix mirrors the location of the special designation symbol or symbols of the base game. Thus, if a special designation symbol was generated in the third row of the second column, the field described by the third row of the second column would be marked or daubed in the second matrix.

As mentioned, the secondary game continues although the player may continue to re-play the base game. Thus, the player's second matrix may include some marked fields during subsequent plays of the base game. When the player has reached a point where the second matrix that has accumulated sufficient marks or daubs to display a pre-determined pattern, the game will have achieved a winning outcome and the player will be awarded the associated award for such win.

The player is incentivized to continue playing the base game in order to have an opportunity of achieving a win in the secondary game. One embodiment to further incentivize play is to introduce a timer such that the player has a set amount of time in which to accumulate the necessary marks or daubs. If the player has not achieved the pre-determined pattern within the limits of time, the second matrix will be cleared of any accumulated marks or daubs to that point and the secondary game will begin anew or time out for some period before it once again initiates.

A further embodiment of the invention requires the player to wager a certain threshold amount in order to be eligible for the secondary game in a given round of play of the base game. Thus, if the player has not wagered the threshold amount, the player will not have the second matrix daubed regardless of whether a special designation symbol appears in the symbol-matrix of the base game. The minimum threshold amount may be the maximum number of paylines and the maximum wager per payline. Therefore, if a nine payline game and a max wager per payline of five credits, a 45 credit wager would be required to enable the secondary game for a given play of the base game.

In yet another embodiment of the invention, the secondary game can be used with a networked system of slot machines. This creates competition among a plurality of players to win the secondary game award. If the award is a progressive, it also provides the ability to grow the award over time with each wager made by a player by setting aside a portion of the wager for contribution to the progressive award. In a networked system of slot machines, the first player to accumulate the necessary marks or daubs in their respective second matrix would win the award associated with the secondary game. The secondary game may allow for more than one player to win an award. Each award may be of different value depending on when it was won. Alternatively or in addition the secondary game may have more than one pre-determined pattern that can be obtained over a series of base game plays to achieve a win. One such pattern may be statistically more difficult to achieve than another and therefore subject to a greater prize award. The networked system may also include a time thereby establishing an initiation point for play of the secondary game and an ending point. If no player achieved a win during that session, the award will grow if a progressive incentivizing more players and the same players to play the next session. As in the standalone embodiments described above, a minimum threshold wager may be required to enable the secondary game.

Other objects, features and advantages of the invention will become apparent from reading the detailed description, herein, and from viewing the drawings.

### DRAWINGS

FIG. 1 shows an electronic gaming device.

FIG. 2 shows a schematic of an electronic gaming device.

FIG. 3 shows a schematic of a basic gaming system for personal computers and mobile devices.

FIG. 4 shows the matrix of a symbol-matrix game.

FIG. 5 shows a symbol-matrix game and secondary game of the preferred embodiment of the present invention.

FIG. 6 shows a flow chart of the preferred embodiment of the present invention.

FIG. 7 shows parameters associated with an embodiment of the present invention having a constant award.

FIG. 8 shows parameters associated with an embodiment of the present invention having a variable award.

### DETAILED DESCRIPTION

The present invention relates to a gaming method and device that enhances and is associated with the play of a symbol-matrix game (later described). In the preferred embodiment, the present invention is a device or system that possesses the basic functionalities of receiving a wager as a prerequisite to playing a game of chance; operating and displaying a symbol-matrix game; and providing a return based on a winning outcome. Therefore, the preferred embodiment is a device or system that is capable of providing wager-based gaming. However, to practice the present invention, the elements of wagering need not be present. All that is essentially required is enablement of the operation and display of a symbol-matrix game. The invention shall be described hereinafter primarily in relation to its preferred embodiment.

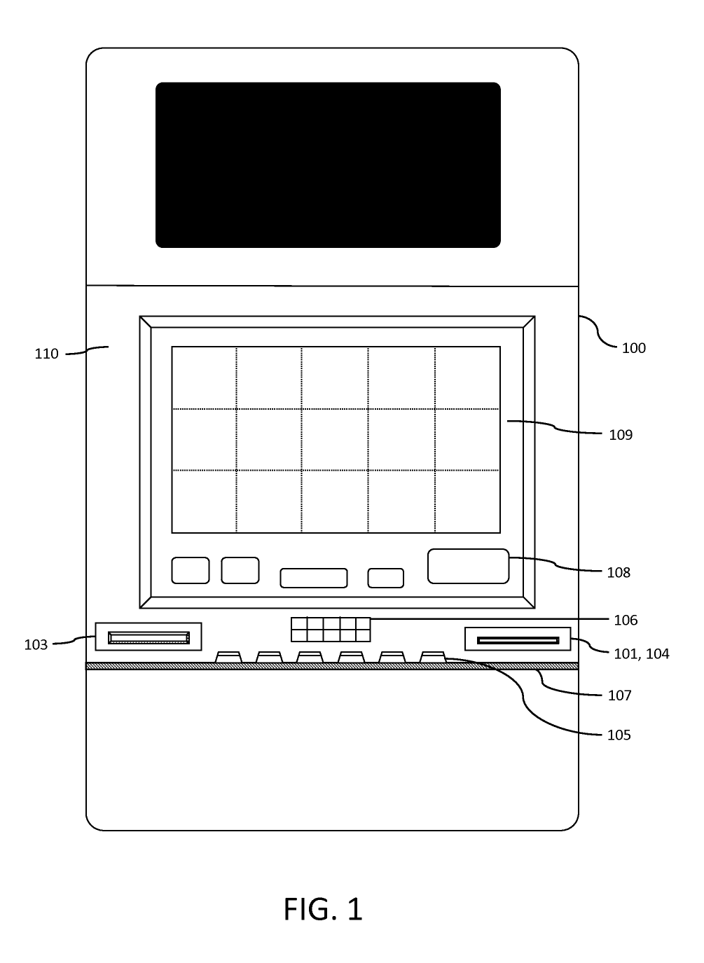

A representative device embodying the invention is displayed in FIG. 1. FIG. 1 depicts a typical video-based slot machine; sometimes referred to as just a slot machine, a video gaming machine, electronic gaming machine or a gaming device. Certain aspects of the slot machine, most of which are inherent in the other devices that may also embody the invention, have bearing on the preferred embodiment of the present invention and thus, a general description inclusive of these features is described.

The slot machine 100 includes a number of input devices associated with making a wager to play the game embodied in the slot machine. Such input devices include, but are not limited to, the following peripheral or component devices: a bill validator 101, a coin acceptor (not shown), a card acceptor 103 for reading credit cards, debit cards and other forms of smart cards used for transferring credit or monies, or a cashless ticketing device 104, which may have the dual function of operating as a bill validatory 101 (as shown in FIG. 1), which established through an internally dedicated ticket system that provides for the transfer of coin, currency, or credit to a secure, currency-bearing ticket that may then be used in association with wagering at the slot machine in lieu of currency, coin or cards. The input devices accept the currency, coin, credit, or ticket, respectively, and allocate the specified amounts to the slot machine 100. Such amounts are then made available to a player to make wagers on the play of the game embodied in the slot machine. Additional input devices, including but not limited to buttons 105 and keypads 106 located on the button panel 107 of the slot machine 100 allow the player to select the denomination to be wagered, which, dependent on the denomination selected, causes the amount input to the slot machine to convert to a number of available credits. A credit meter 108 shows the number of credits available for wager at any given time in accordance with the selected denomination. The player may also select through the input devices the number of paylines (later described) on which to wager and the number of credits to wager per payline. The game associated with the slot machine may have a maximum number of paylines and a maximum number of credits that may be wagered per payline to establish an overall maximum wager for each play of a game. Another means for inputting the selection of denomination, number of paylines and the number of credits per payline, or for other required inputs such as volume control or input related to game play activities, is a capacitive surface interface (not shown) associated with the display screen 109. The capacitive surface interface receives input through player touch of the display screen which then localizes the change in capacitance, maps the location, and processes a given form of input based on the defined location (e.g. denomination selection, number of paylines, etc.).

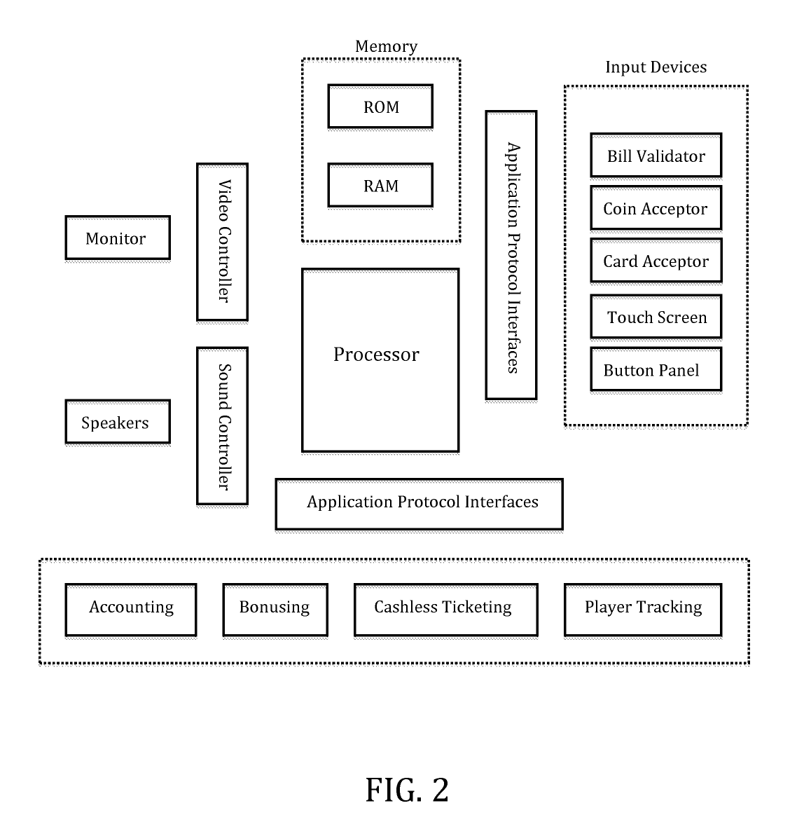

FIG. 2 shows a schematic diagram of many of the primary components, devices and features of the slot machine, including the input devices noted above. In addition to the bill collector, coin acceptor, card acceptor, cashless ticketing system and touch screen interface, other basic components of the slot machine include at least one processor, at least one memory device, and at least one display. The memory stores computer instructions that are executed through the at least one processor to carry out operations communicated to the various devices and components of the slot machine. These instructions include how to accept the currency, coin, credit or currency-bearing ticket and how to handle player input associated with making a wager. The processor reads the applicable input for initiating the play of the game and then processes the game code stored in memory to operate the dynamics of game play. In the event of a winning outcome resulting in a return to the player of a portion, all or multiples of the amount wagered, the processor executes instructions to distribute credits to the credit meter based on the currently selected denomination. Alternatively, and primarily in older model slot machines, the return to the player is provided directly to the player in the form of coins. In these slot machines, there may be only one denomination available and the slot machine may or may not include a credit meter. Input to a more modem slot machine requesting “cash-out” generally results in a currency-bearing ticket, which can then be redeemed for cash at specialized kiosks that are linked to the cashless ticket system and can identify the ticket and the associated value, or from an operator that can also determine the value of the ticket from a select device linked to the system and therefore provide the applicable amount of currency in exchange for the ticket. Card acceptors are another means, as indicated above, for delivering funds to the slot machine for play and for providing stored amounts back to the card when the player cashes out. Other components associated with the slot machine and gaming activity are further shown in FIG. 2.

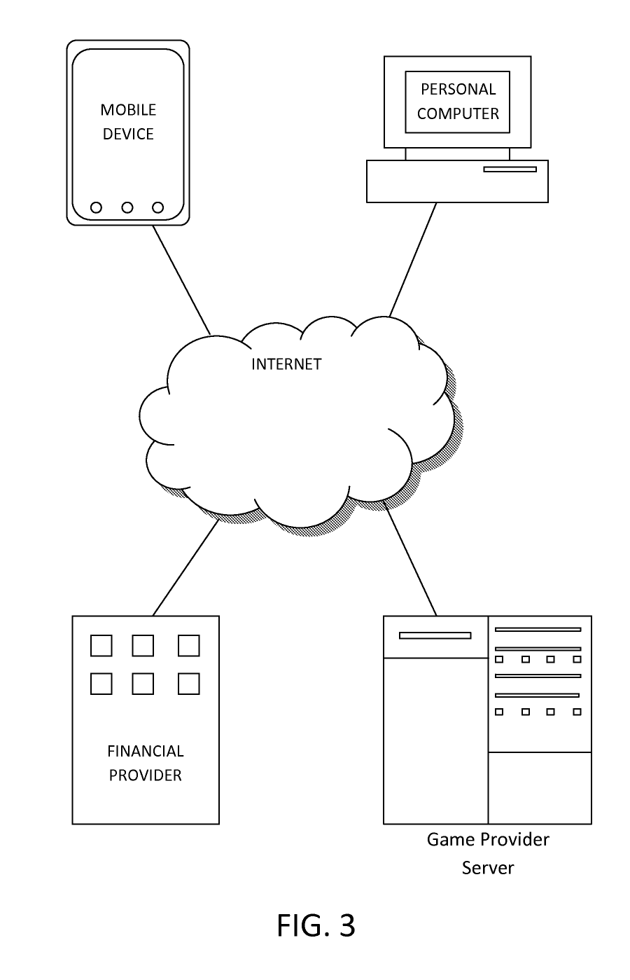

Other representative devices that embody the invention are personal computers and mobile devices, such as smart phones, tablet devices and lap top computers. Use of such devices for wagered gaming has risen in recent years with the advent of the Internet and the legalization of wager-based gaming through the Internet to various locations throughout the world. These devices include many of the same basic elements as the slot machine. However, the secure gaming operations and financial transactions are conducted remotely through a secure server that communicates with the personal computer through the Internet. FIG. 3 generally depicts an Internet-based gaming system. All devices are linked and in communication with the other through the Internet.

The input means of a personal computer and mobile device are generally known. They include such components or peripheral devices as a mouse, keyboard, and keypad. But can also include a capacitive surface interface similar to that used with the slot machine display screen. The personal computer and mobile device also include a display screen and at least one processor for computing electronic operations. The personal computer and mobile device access and conduct communications with the Internet or other established wide area network to conduct wager-based gaming. Electronic funds transfer is provided between the player located at the personal computer or mobile device and a financial provider to securely transfer funds to the game provider. Game operations are securely conducted between the game provider and the player to play the game and determine a win or loss. This must be conducted remotely and under a secure server environment as dictated and regulated by applicable gaming authorities.

More specifically, to conduct Internet or networked gaming, the personal computer or mobile device establishes communications with the server of an online game provider by identifying the server by the server's unique uniform resource locator or URL through a web browser and transmitting a call. A web browser, an application stored in the user's personal computer, enables communications through the Internet to other nodes within the network of nodes defining the Internet, including the game provider server. Mobile devices use platforms different than browsers, such as iOS for use with Apple mobile devices and Android for use with a variety of other manufacturer's mobile devices, but the purpose and results are substantially similar. Communication links to and from the Internet are established via wire, such as cable, digital subscriber line, or the like, or through wireless transmission such as satellite, Wi-Fi, or the like. Established communication protocols are used to control data download and data upload, and to ensure the nodes can read the data being sent from other nodes. Communications are thus established between the personal computer or mobile device and the online game provider's server. The online game provider houses a repository of virtual wager-based games of chance that a player may select for play. That information is communicated to the personal computer and shown on its display. The provider's server also contains the software and content, stored in a memory device, which is processed through one or more processors and streamed or downloaded through the Internet to the personal computer to enable the display and play of the various games. The server maintains the electronic infrastructure to securely conduct financial transactions with a financial provider, track the amount of funds deposited to an account established for a given player, use the funds to finance the play of the games, track the deductions and credits to such account based on wagers made and game outcomes, and to process the coded instructions that allow for the play of the game and the determination of game outcomes. After an account is established with the online game provider, currency is deposited through means generally available for making online purchases.

In those jurisdictions where it is illegal to conduct wager-based Internet gaming, it may still be possible to practice the present invention through other forms of gaming—often referred to as social gaming—whereby virtual currency may be wagered in lieu of genuine currency, credit or other form of legal tender. Virtual currency is currency that exists and has use only within a social gaming Internet site. It provides for the play of games or to purchase virtual indicia within the social game to enhance or enable the play of the game; as opposed to genuine currency that is generally available to purchase goods and services of any kind throughout the world. For a game of chance within a social gaming site, the virtual currency can be used in a manner similar to genuine currency such that a player can make a wager on the game in consideration for a chance to receive a winning outcome. A winning outcome may provide additional virtual currency but it is only useable within the social gaming site. Virtual currency is acquired in such a way, but can also be purchased or received as part of a promotion, contest or as a gift. The present invention provides for both the wagering of virtual currency within a social gaming environment and real money wagering within legal gambling jurisdictions and can be practiced in both environments. The game provider generally displays a number of games available for the player to play. The player selects one of the games. The graphical and video representation of the game is streamed through the Internet or wide area network to the player's personal computer or mobile device. An amount specified by the player, or the amount held in the player's account is credited to the video game for play.

Regardless of the device used to embody the invention; be it a slot machine, personal computer, or mobile device, or the means used for initiating a wager, the input and output devices, or the type of display, once the wager is made and play of the game is initiated, the game dynamics are displayed on the at least one display or monitor 207. Additional input may be required during the course of the game. If so, as indicated above, such input is provided, if a slot machine, through the button panel 208 controls or through the touch-screen interface of the monitor 207. Similarly, if a personal computer, through the mouse, keyboard or touch screen and, if a mobile device, through a keypad or touch screen. All of the representative devices possess memory 206 to store computer code and at least one processor 205 to process the operations of the game and include all of the necessary input, output and display elements to securely carry out at least the same primary elements of the present invention. Thus, the functionality to securely process the receipt and delivery of funds, allow a player to make a wager, and to process and display the play of a game. Slot machines, personal computers, and mobile devices can securely perform such functions.

All of the representative devices noted may operate games in a standalone mode or may be networked together for the purpose of enabling game play interaction between players (i.e. “network mode”). In standalone mode, games are individually played, with no interaction to games played by players on other devices. Additionally, potential awards available from a winning outcome from the game being played on the device are directed solely to that game and to no other game on any other device. Thus, in standalone mode a game is played in an isolated state with respect to the game play and the awards that can be achieved. Personal computers and mobile devices are inherently linked to a network-based system; i.e. the Internet or other wide area network, but in regards to interaction between players for the purposes of game play, there is no interaction between players for the purposes of game play. Slot machines in standalone mode may still be linked to a network-based system for certain peripheral purposes, such as player tracking, game delivery, or to perform back end accounting functions. However, again, when in standalone mode there is no interaction between the players of different slot machines for the purposes of game play or award sharing. When games operate in network mode, collaboration is enabled in regards to game play or to enable all players to have a chance at achieving or sharing in a certain award. This is seen with progressive jackpots that grow in size through contributions from portions of the players' wagers that use the machines linked to the network; whether an intranet or local area network, or the Internet or other wide area network. Network mode is also seen with games that include a common bonus game in which all or some of the players may participate. There could also be a secondary game common to all or some of the players using devices linked to the network but that only one or some may win. As will be shown, the preferred embodiment utilizes a network of devices to offer a secondary or complementary game that any player playing a game linked to the network could win, but only one or some will win. Thus, by networking the noted devices together through a network, including a server-based gaming system, enhanced game play and additional forms of game play can be achieved.

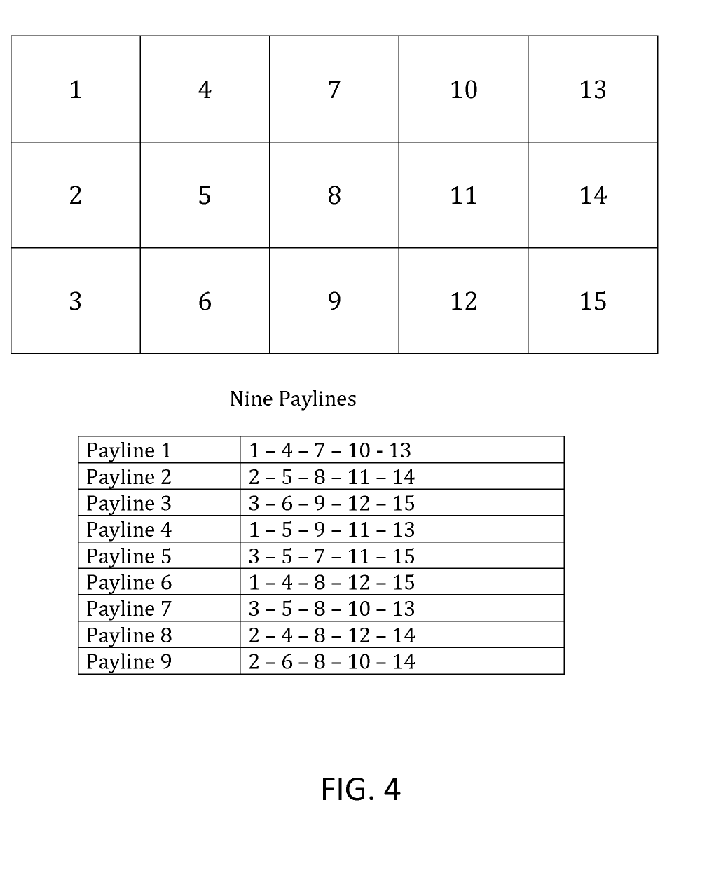

The symbol-matrix game, referenced above, comprises a number of rows and columns that generate a matrix such as that shown in FIG. 4. It can be embodied in any of the representative devices. The matrix may consist of any number of rows and columns. FIG. 4 shows a symbol-matrix game having a 3×5 matrix: therefore, a matrix having three rows, five columns and 15 separate fields as represented by the numbers 1 through 15. The game further defines a plurality of distinct symbols (not shown), and at least one defined set of symbols allocated to each column of the matrix that consists of all or some of the symbols from the plurality of distinct symbols. Each symbol within the at least one defined set of symbols is represented none, one or more times within the set. Therefore, if the symbol set consists of the seven symbols A, B, C, D, E, F and S, and each column of the matrix is allocated a symbol set consisting of 40 symbols, then, for example, each column may consist of the following symbols:

### Column 1: 10A, 8B, 5C, 3D, 3E, 7F, 4S

### Column 2: 11A, 7B, 6C, 5D, 4E, 5F, 2S

### Column 3: 10A, 8B, 5C, 3D, 3E, 8F, 3S

### Column 4: 11A, 7B, 6C, 4D, 2E, 8F, 2S

### Column 5: 9A, 8B, 9C, 6D, 6E, 0F, 2S

Where the letters represent distinct symbols and the number preceding the symbol represents the number of instances within the symbol set.

However, it is not a requirement of the invention that the symbols be allocated in such a manner and this method is described merely as an example. The symbol-matrix game may include any manner of randomly allocating symbols to the fields of the matrix.

After input by a player, a random number generator randomly selects the symbols from each of the symbol sets to be displayed in each of the fields of the respective columns. Winning outcomes are then determined through pre-determined symbol combinations generated along a defined payline. The payline paths, as well as the number of paylines, are defined by design and set as constant parameters of the game. FIG. 4 shows the paths of nine different paylines 404-412. The presently described game may allow a player to select one or more paylines for play, but only up to a maximum of nine paylines in this illustration. Player input generally required to initiate game play is the selection of a number of paylines on which the player wishes to make a wager and then the number of credits to be assigned to each of those paylines. Thus, a wager is placed per payline as well as a total wager for the entire play of the game based on the credit amounts and the denomination assigned to each credit. Further input may be required to then randomly populate the fields of the matrix' columns with the symbols allocated from the applicable symbol sets. A comparison is performed as between the symbol combination outcomes along actively selected paylines and to a table of pre-determined winning outcomes defined by the game (for instance, one winning outcome might be a ‘7’ symbol in each of the first three columns). If a match is found, an award is provided to the player. Multiple awards may be provided if more than one payline includes a winning symbol combination. Although the above is a description of a basic symbol-matrix game, the present invention may be practiced in conjunction with numerous variations of, or additional features to the above described game. The present invention can be practiced with any symbol-matrix game that includes a plurality of fields and that are randomly populated with symbols (or other indicia). For instance, the matrix of fields may be rectangular, as is the 3×5 matrix described above, or of any shape. Some fields used in association with the present invention may be disassociated from the matrix and not associated with any payline, but present in the game for some other purpose. Further, there may be multiple matrices, disassociated fields (i.e. not part of a matrix), or a combination, thereto. Thus, the symbol-matrix game is a game consisting of more than one field, which may include additional disassociated fields and or a matrix of fields, all of which become randomly populated by symbols. The preferred embodiment of the present invention shall continue to be described as the 3×5 symbol-matrix game described, above.

In order to profitably conduct business in the wagered-gaming markets (and also to operate virtual casinos used in the social gaming markets) for their respective owners and operators, the devices must retain on average a percentage of the monies wagered by the players. This amount is referred to as the hold percentage, hold, or the win per unit. The converse of the hold percentage is the average percent return to player (“RTP”); also referred to as the payout percentage or the expected return. The allowable percentages are dictated through the laws, rules or regulations enacted by local gaming authorities authorized to make such for a given wagered gaming jurisdiction. Stated differently, over an infinite number of plays of a game, the amount of money, coin or credit, as applicable, returned to the player from the aggregate of all winning outcomes will be less than the amount of money wagered by the player. The percentage difference between the amount wagered and the amount returned to the player is the hold percentage, and is the percentage amount retained by the game provider.

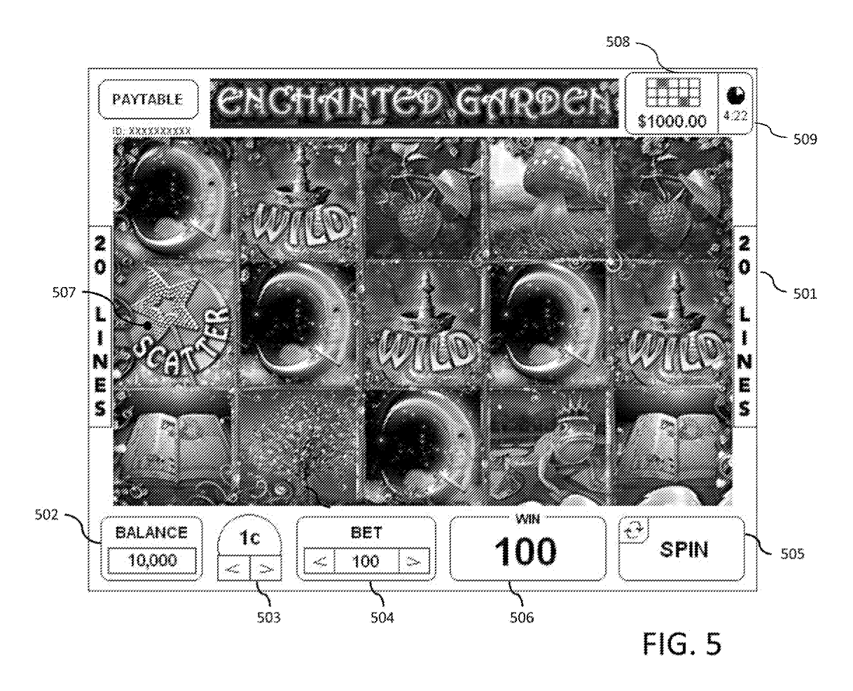

In the present invention, a specified symbol from the set of distinct symbols used in the symbol-matrix game is provided a special designation, the purpose for which will be discussed. FIG. 5 shows a typical symbol-matrix game having a 3×5 matrix of 15 fields. This representative game is a constant payline game having 20 paylines 501, and includes a credit meter 502, denomination selection input 503, and a total wager amount selection input 504, which is apportioned between the 20 paylines. In this illustration, with the selection of a once cent denomination and a total wager of 100, the wager per payline would be five cents. The game also includes “spin” input 505 to initiate play of the game and a “win” meter 506 to show the number of credits won per game play. In the present embodiment the scatter symbol 507 is the symbol from the symbol set having the special designation. A scatter symbol in a symbol-matrix game is a symbol that possesses value in terms of a potentially winning outcome irrespective of any association with a payline. Therefore, regardless of where the scatter symbol randomly appears within the matrix, it possesses value merely by the scatter symbol's selection and inclusion within the matrix. For this reason the appearance of scatter symbols are generally not accorded a relatively high probability of appearing within the matrix. This is because the aggregate of winning outcomes, therefore winning outcomes from all possible scatter symbol wins and wins from all of the designated payline symbol combinations, must remain below a hold percentage of 100%. If the scatter symbol were over-represented within the symbol set and could therefore be frequently selected, then winning outcomes from scatter symbol selections might be too common an occurrence causing the hold percentage to move above the 100% threshold. A mathematical balance exits such that the less winning outcomes designed in to the symbol-matrix game from symbol payline combinations, the more winning outcomes that may be provided from scatter symbols and therefore a higher frequency of scatter symbol selections, while maintaining the hold percentage below 100%. In most symbol-matrix games, winnings from scatter symbol selections are secondary to wins from payline symbol combinations and scatter symbol wins are added to the game for additional entertainment value. Thus, scatter symbols are not one of the more often-selected symbols. To allow for the increase in their selection, the symbol-matrix game may allocate a winning outcome only if two or more scatter symbols are selected and appear within the matrix. The selection and appearance of scatter symbols can therefore be controlled through the mathematical design of the game, which is influenced by such factors as the number of scatter symbols allocated to symbol sets, the numbers of scatter symbols required to generate a winning outcome, and the amount allotted to the winning outcomes for each of the scatter symbol wins.

Although the scatter symbol in this embodiment has been provided with a special designation, in another embodiment a different symbol or a number of symbols could be accorded such designation. Additionally, a distinct symbol could be defined within the symbol set for the sole purpose of having such special designation without having any other attribute. Further, a distinct symbol or symbols within the symbol set that give rise to some other feature of the game; such as a bonus game, free spins or a multiplier to winning outcomes, could possess the dual purpose of having such special designation. Therefore, the distinct symbol which is given the special designation status may have no value apart from the value attributed to the symbol's special designation selection, value unrelated to its value as a special designation symbol, and/or value as a symbol used in a winning payline combination. The value of any such special designation, whether it has secondary value as a scatter symbol, a symbol that may be used in a winning payline combination, or value in providing some other game feature, will become apparent.

Both FIGS. 4 and 5 display a matrix display the matrix used in the symbol-matrix game (hereinafter referred to as the primary matrix). FIG. 5 also displays a second image 508 that is representative of the primary matrix (hereinafter referred to as the representative image). The representative image 508 is shown on the display screen in a manner adjacent to the primary matrix of the symbol-matrix game. It is advantageous to display the representative image in a size smaller than that of the primary matrix to allow sufficient display area for the display of the primary matrix and to emphasize the complementary nature of the game feature represented by the representative image. Alternatively, the representative image could be displayed on a second or separate display screen with the size, therefore, being of less importance and only limited by the display area of the second or separate display screen. The representative image possesses the same basic shape as the image of the primary matrix and includes the same number of fields. Therefore, in this embodiment, the representative image is also a 3×5 matrix and appears similar to that of the primary matrix, but without the inclusion of symbols or other indicia. A timer 509 is displayed adjacent the representative matrix. The purposes for both the representative matrix and the time will become apparent.

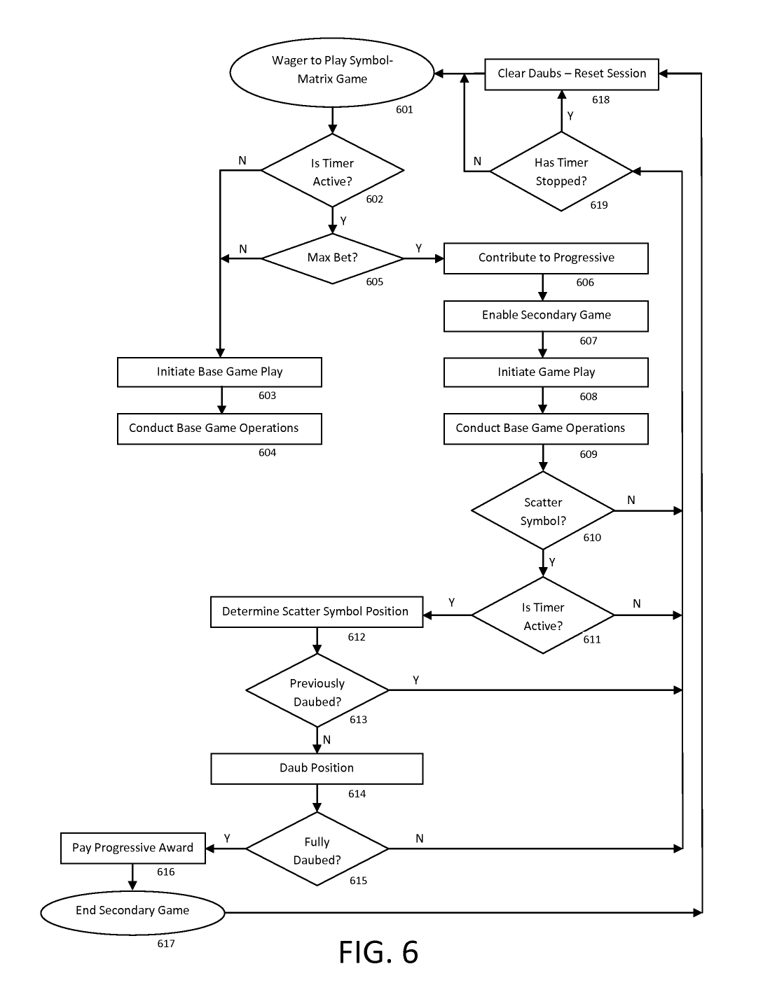

The present invention is practiced in conjunction with the symbol-matrix game and is complementary thereto. Reference is now made to FIG. 6. As discussed above, a wager is first made to play the symbol matrix game 601. The wager is a combination of the denomination selected, the number of paylines selected and the wager per payline. If the game has a set number of paylines (as illustrated in FIG. 5), or only one denomination, then only a wager amount is selected. In the preferred embodiment of the present invention, the secondary game is played during a given period of time, and a timer is displayed to show that the secondary game is enabled and active. Thus, to see if the secondary game is available for play by the player, a determination is made to see if the timer is active 602. If the timer is not active, the secondary game is inactive and only base game play is initiated 603. The processor then conducts base game operations 604, which are the operations to carry out the play of the symbol-matrix game, to determine the outcome of the game and to conduct the necessary financial and credit metering transactions. Thus, the symbol outlay of the primary matrix is assessed to determine if any of the actively selected paylines contain a winning symbol combination and to determine if scatter symbols appear in a quantity necessary to generate a winning outcome. The player is paid or credited, accordingly, in the event of one or more winning symbol combinations and/or scatter symbol wins. If the timer is active 602, a determination is made in this embodiment as to the amount of the wager 605. If the amount was the maximum possible bet (i.e. the maximum number of paylines and the maximum wager per payline), a portion of the player's wager is contributed to a progressive award 606 and the secondary game is enabled 607. If the amount of the wager was not the maximum possible bet 605, the base game is initiated for play 603 without the availability of the secondary game and base game operations commence 604. Similarly, after contribution to the progressive 606 and enablement of the secondary game 607, the base game is initiated 608 while the secondary game is active, and the base game operations commence 609.

After the primary matrix of the symbol-matrix game is randomly filled with symbols, a determination is made to see if any of the symbols are the scatter symbol 610. In this embodiment, scatter symbols are granted the special designation status. If no scatter symbols are determined to reside within the primary matrix, the player either ceases play or continues to play the symbol-matrix game by making another wager 601. Thus, if one or more scatter symbols are determined to reside within one or more fields of the matrix and the timer remains active 611, indicating that the secondary game is still in progress, then the position of the one or more fields containing a scatter symbol are determined 612. Otherwise, the player may once again choose to cease play or make another wager to play the symbol-matrix game 601. However, before re-wagering to play the symbol-matrix game a subsequent time, the processor determines if the timer has stopped and if there are any daubs within the player's representative matrix 619. If daubs appear in the representative matrix and the timer has ceased, this indicates that the secondary game session has timed out or that another player playing in network mode (i.e. not as a standalone device) has met the conditions for a win in the secondary game and has won the progressive award. The secondary game is then reset 618 and a new secondary game session is begun. The player's representative matrix is cleared of daubs through the reset process 618. A time lag may occur between each subsequent secondary game session whereby the ability to enter play of the secondary game is suspended, regardless of wager.

When scatter symbols are generated within the primary matrix, the scatter symbol positions are determined by reading the specific row and column in which the field is located. The same such positioned field of the representative image is then daubed, marked or otherwise designated 614 through the insertion of a symbol or other indicia, to indicate that the special designation symbol in the primary matrix; i.e. the scatter symbol, was randomly selected for generation within that specific field. If the position was previously daubed in the representative image 613, it would indicate that the scatter symbol was positioned within that field of the primary matrix during a previously play of the symbol-matrix game during that same secondary game session and thus the daubing action would be voided in this instance or duplicated without providing any additional visual or function affect. The player then ceases play or initiates another play of the base game 601. If the representative matrix is newly daubed to indicate a first instance of a scatter symbol within the primary matrix during a given secondary session, another assessment is made to determine if each and every field within the representative image is daubed 615. If not yet fully daubed, the player again may wager and re-initiate play of the base game 601. Thus, the play of the symbol-matrix game may be repeated numerous times while the secondary game remains active. If all of the determinations allow for continued enablement of the given secondary game session for the player, each time the player plays the base game, the primary matrix is assessed and, if a scatter symbol is positioned within one or more of the fields, the corresponding field or fields of the representative image are daubed. If the player plays a sufficient number of symbol-matrix games within the period of time allotted to the given secondary game to fully daub each and every field of the representative image, the player is then paid the progressive award 616. The secondary game would then end 617 and the timer would stop. The representative matrix of all players involved in the secondary game would be cleared of daubs and reset 618 for the initiation of a new secondary game. The secondary game will be reset 618 even if time remained when the player's representative image received the final daub to fully daub the image. In other embodiments, other players may continue to play the same secondary game session within the allotted from length of time accorded to the secondary game to have a chance of receiving a secondary progressive award or other consolation award.

As indicated above, the invention can be practiced with devices in standalone mode or in a network mode. In the preferred embodiment, a plurality of devices; whether slot machines, personal computers, or mobile devices, are linked together to form a network-based system. The devices are thus in communication with each other through the electronic communications network; namely through the Internet, a wide area network (WAN) or local area network (LAN), and are operating in network mode. At a given start time, system programming links the play of the symbol-matrix game to the secondary game and performs various operations associated with the secondary game. Each representative image on all devices that are participating in the secondary game is cleared of daubs. A timer display on each device is simultaneously initiated. Each of the players plays the symbol-matrix game on the respective device associated with the placement of a wager by the player. Each time a scatter symbol is generated within the primary matrix on their device, as described above, the respective representative image is daubed. This process is repeated a number of times until either (i) a pre-defined time limit on the displayed timer expires, or (ii) at least one of the players has a representative image that is fully daubed. Therefore, in (ii), each and every field of the representative image is daubed, marked or displays a symbol or other form of indicia. A fully daubed representative image indicates that the scatter symbol was generated in each of the fields of the primary matrix over a period of plays of the symbol-matrix game. If the representative image associated with the player's device is fully daubed, the player is paid or credited, as applicable, an award separate and distinct from any award provided in the symbol-matrix game. The award may be associated with a progressive award whereby the amount of the award is associated with a portion taken from of each player's wager to fund a award, as seen in the method shown in FIG. 6 where the player funds the progressive award when the player wagers the maximum while the secondary game is enabled, thereby allowing it to increase in proportion to the number of times the symbol-matrix game is played. The progressive award amount may be re-set to some designated starting amount after being won. Different levels of progressive awards may be available and distributed based on different outcomes. For instance, if a second player achieves a fully daubed representative image within the time limit established for the secondary game session, that player may receive a lesser, secondary progressive award. The award associated with a fully daubed representative image may also be a set monetary prize amount or some other form of award that is constant and does not accumulate. After the player or players have won the prize or prizes associated with a fully-daubed representative image or the pre-defined time limit has expired, the displays of each representative image from each device are cleared of daubs and the displayed timer is re-set. The described secondary game can then begin anew.

The RTP in the secondary game can be designed to provide relatively large return to the player relative to the RTP of the base game, or designed to have a lesser affect on the overall gaming experience and provide a minimal return. In one embodiment of the invention, if, for instance, a return to player (“RTP”) of ninety five percent (95%) is desired and the base game, which is the symbol-matrix game, provides a RTP of eighty percent (80%), the RTP from the play of the secondary game is designed to provide a RTP of fifteen percent (15%). The parameters of such embodiment might, for instance, be as follows: (i) a timer length (“t”) in the secondary game set at two minutes; (ii) a statistical frequency given the allocation of scatter symbols in the symbol set(s) of this illustrative symbol-matrix game causing a representative image to be fully-daubed every 25 plays of the secondary game. Therefore, based on a maximum number of plays per minute of 20 (“s”), the player will play the symbol-matrix game no more than 40 times before the timer has expired and the representative image is cleared of daubs and reset. It will take the player on average in this embodiment 25 plays (“f”) of the secondary game before the player achieves a fully-daubed representative image and a win of the secondary game award; (iii) an award to the winner(s) of 200 credits (“j”); and (iv) a total of 10 players (“p”), each playing to try and achieve the award in the secondary game. Given these parameters, an RTP is determined as follows:

RTP=j/(2*s*f*p)=200/(40*25*10)=0.150=15.0%

Thus, for every credit wagered to play the symbol-matrix game associated with an active secondary game, the RTP in this illustration would be 80% (from the base game) plus 15% (from the secondary game) for a total of 95%.

The award to the player of 200 credits noted in the above illustration may be an award that is held constant or may be an average award if the award is provided through a progressive. The progressive award grows during the secondary game session and, if not won during that session, continues to grow in subsequent sessions. When finally won, the progressive jackpot award reverts back to a pre-determined starting amount. Some of the funds collected from the player's contributions can be maintained in reserve to finance the starting amount.

When the award (j) is constant (i.e. not a progressive award), the RTP can be adjusted by changing the timer length. For purposes of illustration, a desire to lower the overall RTP could be accomplished using the parameters in the first illustration but changing the timer length (t) to, say, three (3) minutes. Thus, the symbol-matrix game is played a maximum of 60 times for each secondary game session thereby significantly increasing the frequency (f). If a player is able to have more plays during a secondary game session, the scatter symbol will be selected for generation within the primary matrix a greater number of times thereby providing a higher chance (i.e. frequency) of fully daubing the representative image within the given time period. The RIP is similarly adjusted to increase by lowering the timer length (t).

When the award (j) is not constant but is a progressive award that grows with each play of each associated symbol-matrix game, both the timer length (t) and the rate of increase of the award factor into the RTP. Increasing the timer length (t) causes the RTP to move lower, but the continuing contribution to the progressive award (j) tempers that movement as the potential award grows. If the contributions from the players' wagers to fund the progressive award are significantly large, the RTP could remain constant or even move higher.

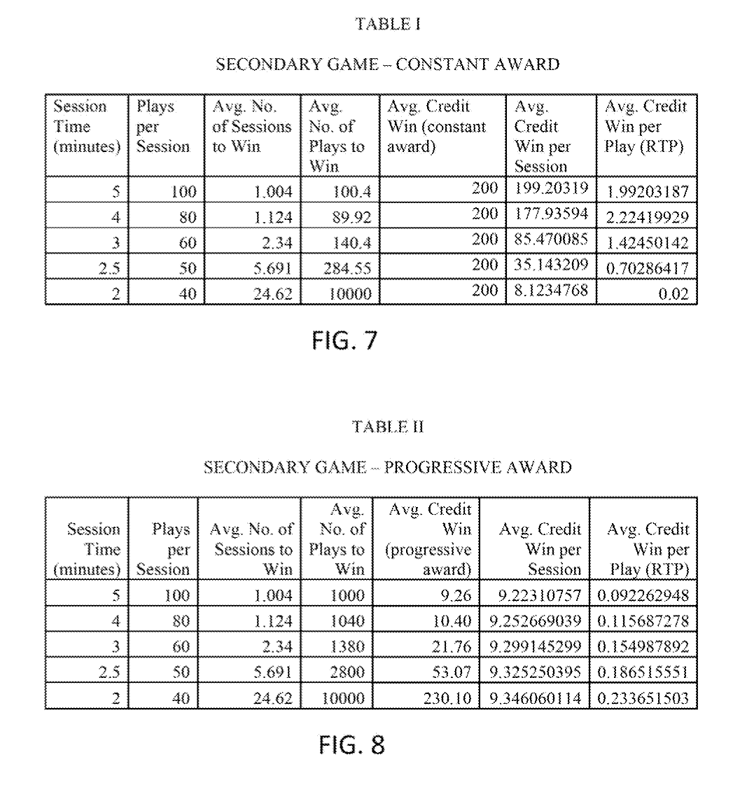

FIG. 7 shows Table I having parameters for an illustrative secondary game when an award of constant value is provided. In this illustration, the award for winning the secondary game (“Avg. Credit Win”) is a set constant of 200 credits regardless of session length (“Session Time”). The player that wins the secondary game will therefore always receive 200 credits; regardless of session time or how many sessions are played prior to triggering the award. The symbol-matrix game delivers a scatter symbol selection frequency that in turn provides an average number of sessions to win (“Avg. No. of Sessions to Win”) specified in Table I. This is a set constant defined by the parameters of the symbol-matrix game and is not affected by the secondary game. Thus, the only variable in Table I is the “Session Time”. In this illustration, the maximum number of plays that the symbol-matrix game can generate per minute is 20. For a two-minute session of the secondary game, this equates to 40 plays of the symbol-matrix game (“Plays per Session”). For a five-minute session, the Plays per Session will increase to 100. Because the scatter symbol selection and generation frequency and the number of plays per minute are constant, the average number of plays of the symbol-matrix game to win (“Avg. No. of Plays to Win”) can be determined. Knowing the number of credits a player will win and the average number of plays that it will take for the symbol-matrix game to achieve such win, the expected return or RTP (“Avg. Credit Win per Play (RTP)”) can then also be determined. As is shown, the RTP increases with Session Time. Since the RTP is a feature related to the expected return from the play of each game, which is a combined expected return from the symbol-matrix game (i.e. base game) and the expected return from the secondary game, if the expected return is set in the base game, the RTP will increase if the expected return in the secondary game is increased. Thus, by increasing the Session Time in a secondary game session having an award of constant value, the players greater chance of winning the award increases the expected return in a secondary game and increases the overall expected return in the game. In the above example, the RTP in the two minute session secondary is two percent and, perhaps, the only practical session length that would provide a practical RTP in the secondary game. To establish a practical RTP for a secondary game of greater session time, the base game would require modification to increase the Avg. No. of Plays to Win, the award would need to be reduced, or a combination of changes to those factors would have to occur. Additionally, the number of players that link to the secondary game could be increased or decreased; an increase causing the RTP to decrease and a decrease in the number of players causing the RTP to increase. The above example presumes a specific number of persons on average playing each session of the secondary game.

FIG. 8 shows Table II having parameters for an illustrative game when a progressive jackpot award is provided. In this illustration, the secondary game award grows with each play of the symbol-matrix game through contributions from the players' wagers until the award is finally won. Thereafter, the award reverts to a pre-determined starting amount and once again grows with each play. The set parameters of Plays per Session and Avg. No. of Sessions to Win are the same as those in Table I. Thus, the Avg. No. of Plays to Win are also the same. Unlike the constant award example of Table I where the RTP increases with session length, in this progressive award example the RTP decreases with session length. One reason for this is that an increase in session length corresponds with an increase in the frequency of achieving a winning outcome in the secondary game (i.e. 24.62 sessions@2 minutes, and 1.004 sessions@5 minutes). Thus, there will be more plays of the symbol-matrix game and more contributions to the progressive jackpot award as the session length decreases. With a secondary game having an award of constant value, the award remains the same regardless of the frequency of achieving a win and therefore the RTP increases with a higher win frequency in the secondary game since the constant award value is won more often by the player increasing his or her return. With the secondary game in Table 1, any of the variable parameters can be altered by the game designer to affect the RTP. With a secondary game having a progressive award, there are more variables that may be modified to affect the RTP of the secondary game. In addition to modifying the base game to alter the frequency of secondary game wins per plays, the amount of contribution of the player's wager can be adjusted; as can the starting amount of the progressive jackpot.

The length of the timer and the frequency of the scatter symbol are related in certain embodiments of the invention. This is due to the fact that, given a fixed hold percentage in the symbol-matrix game (i.e. the base game), a high frequency of scatter symbols selected and displayed in the primary matrix will lead to a relatively high frequency of awards in the secondary game. This in turn will lead to a relatively high percentage return to player from the secondary game, thereby diminishing the hold percentage to potentially an unsustainably low number or even to a negative hold percentage thus making it unprofitable to operate the device. To compensate, the time period for the secondary game session can be shortened to a period that affects the frequency to a degree whereby the wins in the secondary game are sufficiently lowered to place the hold percentage back to a satisfactory amount. Conversely, if the frequency of the scatter symbols is too low, the timer length can be increased to enable a greater possibility for a player to secure a win in the secondary game thus driving the overall hold percentage higher and, potentially, back to a percentage desired by the operator. Thus, given pre-determined, fixed mathematical probabilities of the base game—i.e. the symbol-matrix game—to determine the percentage of winning outcomes, the hold percentage can be adjusted, accordingly, through manipulation of the timer length in the secondary game.

In some embodiments, if the pre-defined time limit has not expired, players who have not yet won may continue to play the symbol-matrix game in an effort to fully daub their respective representative image to achieve a secondary award. In yet other embodiments, the player must wager on the maximum number of paylines and/or wager the maximum number of credits per payline, or alternatively above some minimum threshold amount, to be able to participate in the secondary game (this is included in the preferred embodiment of FIG. 6). In yet another embodiment, there is no timer. However, there is an initiation point. At such point, all representative images are clear of daubs. The players play the symbol-matrix game for an unlimited time until at least one player has a fully daubed representative image.

In still other embodiments, the secondary game is practiced with a standalone device. In these embodiments, communication between devices is not needed to enable use of the complimentary game. The secondary game is similarly played, either subject to a defined time limit or not. If a pre-defined time limit is imposed, then the player plays the secondary game only against the clock and not against any other player. If there is no pre-defined time limit, the player may play until the representative image is fully daubed. In a further embodiment, a player tracking system is used to track the status of the representative image at any given point in time and saves such status in its current state in the memory of the player tracking system. The player may then stop or suspend play of the symbol-matrix game and later re-start play at the same device or at another device linked to the player tracking system and that provides the secondary game. The device identifies the player and the status of the secondary game and delivers the representative image having the same number and position of daubs as previously presented in the representative image at the conclusion of the previous use of the device linked to the player tracking system and having the secondary game. The player then continues to play the symbol-matrix game anew while continuing to play the secondary game from the point last left. This provides incentive to the player to play those symbol-matrix games that are associated with the secondary game. It also provides incentive to revisit play of the symbol-matrix game since, assumedly, less daubs will be required to fully daub the representative image since some daubs may appear from the previous session of play, and therefore the player will have a higher probability of achieving a fully-daubed representative image during the subsequent session of play.

In all of the aforementioned embodiments, the representative matrix may generate a winning outcome when the daubs display a pre-determined pattern on the matrix, such as an “X” pattern, a cross-pattern, or when just the corner-most fields are daubed. Alternatively, certain patterns may generate a secondary or tertiary winning outcome.

It is to be understood that each of the aforementioned embodiments are not to be construed as limiting, but rather as being exemplary of alternative ways of delivering the invention. As such, variations on the above not explicitly provided herein are within the scope of the present invention.

While the invention has been illustrated with respect to the specific embodiments thereof, these embodiments should be considered as illustrative rather than limiting. Various modifications and additions may be made and will be apparent to those skilled in the art.

What is claimed is:

1. A device used for the operation of electronic game play comprising:
at least one input device;
at least one memory storage location for storing instructions associated with a game;
at least one processor, and
at least one display device; wherein upon input associated with a wager made by a player through the at least one input device, the instructions are executed by the at least one processor to (i) display a first plurality of fields wherein each of the first plurality of fields is defined by a specified row and a specified column from a plurality of first rows and first columns positioned to form a bonus matrix, (ii) display within each of a second plurality of fields at least one symbol randomly selected from at least one symbol set, the at least one symbol set including at least one special designation symbol in each of the at least one symbol sets, the second plurality of fields having a number of rows and a number of columns equal to the number of first rows and first columns to form a base game matrix, the relative position of each field in the base game matrix in association with all other of the second plurality of fields being substantially the same as the relative position of each field in the bonus matrix with all other of the first plurality of fields, (iii) determine if one or more of the at least one special designation symbols is displayed within any of the second plurality of fields of the base game matrix, (iv) generate a marker symbol in each of the plurality of first fields of the bonus matrix at the same relative position of the bonus matrix as each field of the base game matrix that displayed the at least one special designation symbol for each special designation symbol displayed in the base game matrix, (v) repeat (ii) through (iv) upon each successive input associated with a wager, and (vi) provide an award to the player when the marker symbol is displayed in each of the first plurality of fields of the bonus matrix.

2. The device of claim 1, wherein the marker symbol is not generated in the field of the plurality of first fields of the bonus matrix that has the same relative position as the field of the plurality of second fields of the base game matrix displaying the special designation symbol when the marker symbol is displayed in said field.

3. The device of claim 1, wherein the player is provided a chance to generate the marker symbol for each of the first plurality of fields of the bonus matrix within a specified period of time.

4. The device of claim 1, wherein the player is provided a chance to generate a marker symbol for each of the first plurality of fields of the bonus matrix within a specified number of wagers.

5. The device of claim 1, wherein the wager must exceed a pre-determined minimum threshold to receive a chance to generate a bonus marker.

6. The device of claim 5, wherein the pre-determined minimum threshold comprises the maximum number of paylines and the maximum wager per payline.

7. An electronic gaming system, wherein said electronic gaming system comprises at least two of the devices of claim 1, each configured to communicate with each of the other at least two devices, and wherein (i) the player associated with each of the at least two devices is provided a chance to generate the marker symbol for each of the first plurality of fields of the bonus matrix, and (ii) the player associated with the device that first generates the marker symbol for each of the first plurality of fields of the bonus matrix is provided the award.

8. The electronic gaming system of claim 7, wherein each of the players is provided a chance to generate the marker symbol for each of the first plurality of fields of the bonus matrix within a specified period of time simultaneously provided to each of said players.

9. The electronic gaming device of claim 1, wherein the player is provided an award when the marker symbols are presented in a pre-defined pattern.

10. A method of game play on a device having input means, memory to store instructions for enabling game play, a display, and at least one processor for carrying out the instructions and displaying the game on the display, the method comprising:
placing a wager through the input means to play a base game in which symbols from at least one symbol set are provided within a first plurality of fields, each of said first plurality of fields having a specified row and a specified column;
displaying within each of said first plurality of fields a symbol randomly selected from at least one symbol set, said symbol set including at least one special designation symbol;
marking a field within a second plurality of fields, each of said second plurality of fields having rows and columns that mirror the specified rows and specified columns of the first plurality of fields, when the special designation symbol is displayed in the first plurality of fields and wherein the marked field consists of the row and column that mirrors the specified row and specified column of the first plurality of fields where the special designation symbol was displayed;
repeating the placing, displaying and marking steps, above, until the second plurality of fields comprises a pre-determined pattern of marked fields; and
providing an award.

11. The method of claim 10 wherein the pre-determined pattern comprises a mark within each of the second plurality of fields.

12. The method of claim 10, wherein the pre-determined pattern of marked fields must be obtained though the repeating, displaying and marking steps within a specified period of time.

13. The method of claim 10, wherein the pre-determined pattern of marked fields must be obtained through the repeating, displaying and marking steps within a specified number of wagers.

14. The method of claim 10, wherein a prerequisite to the marking step is a wager that exceeds a pre-determined minimum threshold.

15. The method of claim 14, wherein the pre-determined minimum threshold comprises selecting the maximum number of paylines and the maximum wager per payline.

16. A method of game play on a plurality of devices each having input means, memory to store instructions for enabling game play, a display, and at least one processor for carrying out the instructions and displaying the game on the display, each of said devices networked with a server having memory to store instructions for enabling networked game play, at least one processor for carrying out the instructions, and communication means for enabling communications between the plurality of devices and the server, comprising:
initiating a timer at the same time for each of the said devices;
performing the following steps for each of said devices:
(i) placing a wager through the input means to play a base game in which symbols from at least one symbol set are provided within a first plurality of fields, each of said first plurality of fields having a specified row and a specified column;
(ii) displaying within each of said first plurality of fields a symbol randomly selected from at least one symbol set, said symbol set including at least one special designation symbol;
(iii) marking a field within a second plurality of fields, each of said second plurality of fields having rows and columns that mirror the specified rows and specified columns of the first plurality of fields, when the special designation symbol is displayed in the first plurality of fields and wherein the marked field consists of the row and column that mirrors the specified row and specified column of the first plurality of fields where the special designation symbol was displayed;
(iv) repeating the placing, displaying and marking steps, above;
providing an award to one or more of the plurality of devices if the second plurality of fields comprises a pre-determined pattern of marked fields within the devices' respective second plurality of fields; and
clearing the second plurality of fields in each of the plurality of devices if the timer has reached a pre-determined period of time.

17. The method of claim 16, wherein the award is a progressive award.

18. The method of claim 16, wherein the pre-determined pattern comprises a mark within each of the second plurality of fields

19. The method of claim 16, wherein a prerequisite to the marking step is a wager that exceeds a pre-determined minimum threshold.

20. The method of claim 19, wherein the pre-determined minimum threshold comprises selecting the maximum number of paylines and the maximum wager per payline.
